(19) United States
(12) Patent Application Publication
(10) Pub. No.: US 2009/0111496 A1
(43) Pub. Date: Apr. 30, 2009

(54) METHOD AND SYSTEM FOR CLASSIFYING BLUETOOTH CHANNELS USING A WIDEBAND RECEIVER

(76) Inventors: Brima Babatunde Ibrahim, Aliso Viejo, CA (US); Steven Deane Hall, Olivenhain, CA (US)

Correspondence Address: MCANDREWS HELD & MALLOY, LTD, 500 WEST MADISON STREET, SUITE 3400, CHICAGO, IL, 60661, US

(21) Appl. No.: 11/930,446

(22) Filed: Oct. 31, 2007

(51) Int. Cl. H04Q 7/20

(52) U.S. Cl. 455/512

(57) ABSTRACT

Aspects of a method and system for classifying Bluetooth channels using a wideband receiver are provided. In this regard, FFT analysis may be utilized to detect signals/interference present in a sub-band of an ISM band and classify Bluetooth channels in that sub-band based on the detected signals. A co-located Bluetooth transceiver may utilize the classification to determine which Bluetooth channels comprise a best communication link for communicating via Bluetooth. In this regard, Bluetooth channels may be ranked in order of preference based on the classification. Preferred Bluetooth channels may provide more reliable Bluetooth communications. The ISM frequency band may be the 2.4 GHz ISM frequency band. The sub-bands may each comprise a WLAN channel. The Bluetooth channels may be classified based on strength, type, and/or a rate of recurrence of the detected signals. In addition to the FFT, a signal strength indicator may be utilized to detect signals/interference.

### CROSS-REFERENCE TO RELATED APPLICATIONS/INCORPORATION BY REFERENCE

Not Applicable

### FIELD OF THE INVENTION

Certain embodiments of the invention relate to wireless communication. More specifically, certain embodiments of the invention relate to a method and system for classifying Bluetooth channels using a wideband receiver.

### BACKGROUND OF THE INVENTION

The wireless communications industry has seen explosive growth in recent years and shows no signs of slowing. For example, Bluetooth and WLAN are technologies that are seeing widespread growth in terms of both numbers and types of compatible devices.

Bluetooth and WLAN both operate on the unlicensed 2.4 GHz ISM frequency band. Consequently, there are many coexistence issues that confront Bluetooth and WLAN system designers. For example, Bluetooth and WLAN networks operated in close proximity may interfere with each other. In this regard, although Bluetooth and WLAN utilize spread spectrum techniques to help mitigate the impact of multiple network in close proximity, the performance of Bluetooth and WLAN networks operating in close proximity may nonetheless be degraded. Accordingly, significant opportunities may exist for improving coexistence of Bluetooth and WLAN, and even for benefiting from Bluetooth and WLAN coexistence.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for classifying Bluetooth channels using a wideband receiver, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1a is a diagram illustrating exemplary scanning of a frequency band utilizing a wideband receiver and dividing the band into a plurality of sub-bands, in accordance with an embodiment of the invention.

FIG. 1b is a diagram illustrating exemplary scanning of a frequency band utilizing a WLAN receiver and five WLAN channels, in accordance with an embodiment of the invention.

FIG. 1c is a diagram illustrating the identification of signals utilizing a wideband receiver and classifying Bluetooth channels based on the identified signals, in accordance with an embodiment of the invention.

FIG. 2 is a block diagram of an exemplary wideband receiver enabled to detect Bluetooth signals, in accordance with an embodiment of the invention.

FIG. 3 is a flow chart illustrating exemplary steps for utilizing a wideband receiver for classifying Bluetooth channels, in accordance with an embodiment of the invention.

FIG. 4 is a diagram of an exemplary portable electronic device comprising integrated support for multiple wireless technologies, in accordance with an embodiment of the invention.

### DETAILED DESCRIPTION OF THE INVENTION

Certain embodiments of the invention may be found in a method and system for classifying Bluetooth channels using a wideband receiver. In this regard, FFT analysis may be utilized to detect signals/interference present in a sub-band of an ISM band and classify Bluetooth channels in that sub-band based on the detected signals. A co-located Bluetooth transceiver may utilize the classification to determine which Bluetooth channels comprise a best communication link for communicating via Bluetooth. In this regard, Bluetooth channels may be ranked in order of preference based on the classification. Preferred Bluetooth channels may provide more reliable Bluetooth communications. The ISM frequency band may be the 2.4 GHz ISM frequency band. The sub-bands may each comprise a WLAN channel. Bluetooth channels may be classified based on strength, type, and/or a rate of recurrence of the detected signals. In addition to the FFT, a signal strength indicator may be utilized to detect signals/interference.

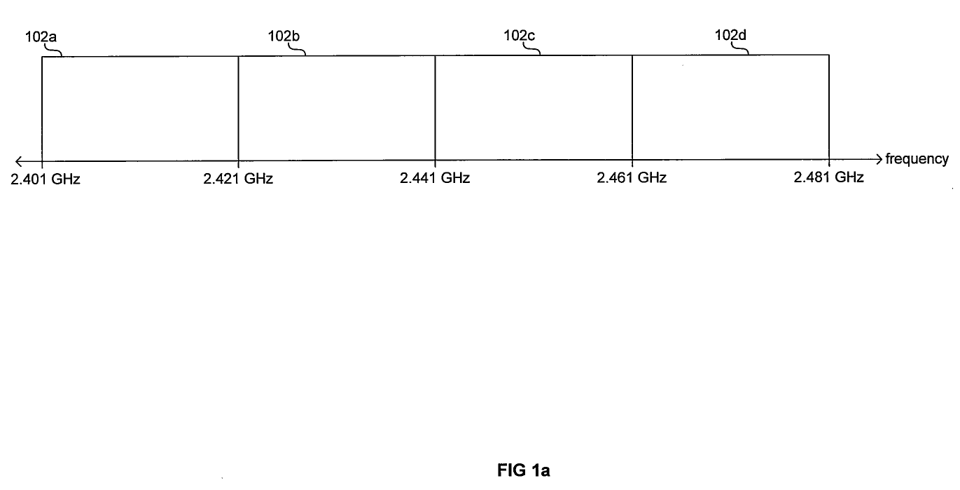

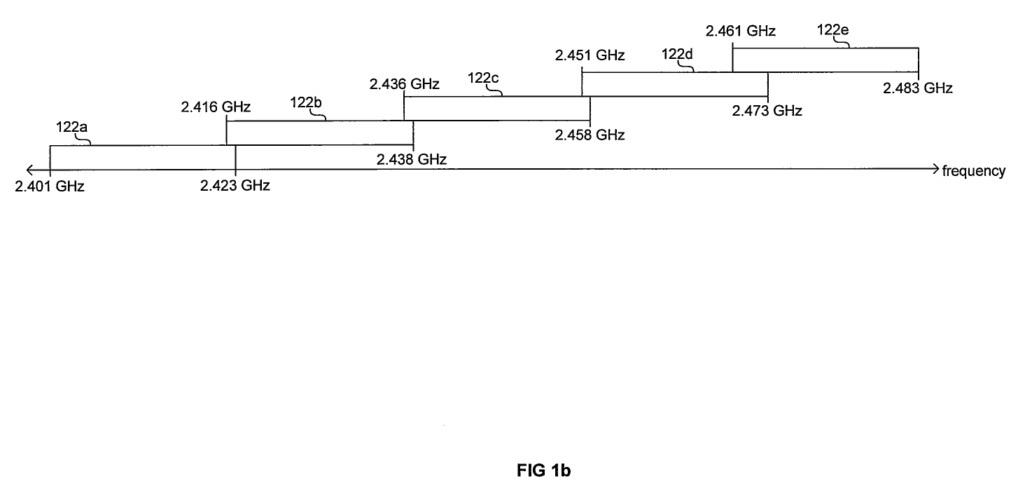

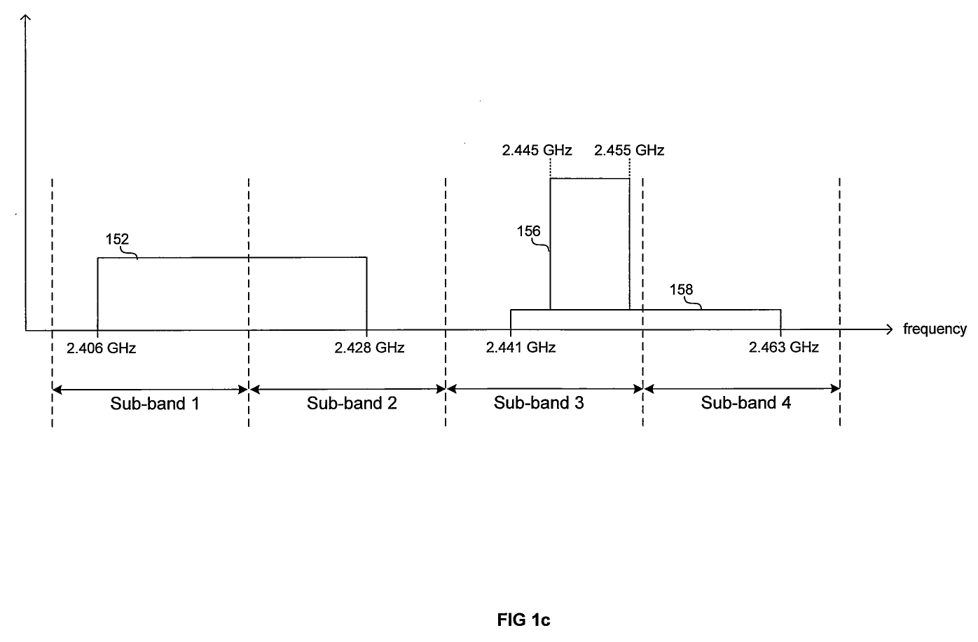

FIG. 1a is a diagram illustrating exemplary scanning a frequency band utilizing a wideband receiver and dividing the band into a plurality of sub-bands, in accordance with an embodiment of the invention. Referring to FIG. 1 there is shown the 2.4 GHz ISM frequency band split into, for example, four 20 MHz wide sub-bands 102a, 102b, 102c, and 102d.

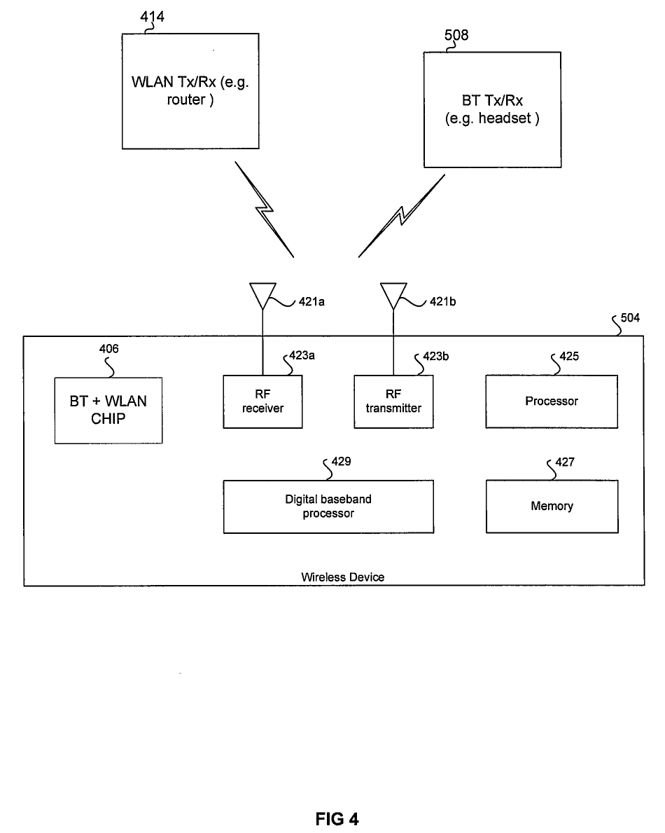

The 2.4 GHz ISM frequency band may extend from 2.401 GHz to 2.483 GHz. Bluetooth may utilize the 2.4 GHz ISM frequency band as described below with respect to FIG. 4a. The four sub-bands 102a, 102b, 102c, and 102d may collectively cover the 79 Bluetooth channels. In the exemplary embodiment of the invention depicted, the sub-bands may each cover approximately 20 MHz, however, sub-bands may cover any bandwidth without deviating from the scope of the invention. For example, three sub-bands of approximately 40 MHz sub-bands may be used.

In an exemplary operation, a wideband receiver may receive on each of the sub-bands for a period of time and may store the received data. A FFT may then be performed on the received data to determine the content of the received signal. In one embodiment of the invention, the FFT may be performed on received data in each band. Alternatively, the wideband receiver may scan the 2.4 GHz ISM frequency band by sequentially measuring the received signal strength in the four sub-bands and perform an FFT when received signal strength is greater than a threshold. The spectral characteristics determined by the FFT may be utilized to identify whether there are signal being transmitted on the sub-band and the type of signals that are being transmitted. For example, the 2.4 GHz ISM band may be shared by, among others, Bluetooth devices, WLAN devices, and microwave ovens. Accordingly, the FFT may be utilized to identify whether Bluetooth, WLAN, microwave oven, and/or other signals and/or interferers may be present in a sub-band. Moreover, when signals such as WLAN, microwave oven radiation, or other non-Bluetooth transmissions are present, aspects of the invention may enable determining which Bluetooth channels are affected by the signals/interference and marking those channels as less desirable or undesirable for Bluetooth transmissions. Moreover, in instances where the FFT identifies Bluetooth transmissions, various aspects of the invention may enable determining a source of the Bluetooth transmission and/or a next channel that may be suitable for Bluetooth transmission.

FIG. 1b is a diagram illustrating exemplary scanning of a frequency band utilizing a WLAN receiver and five WLAN channels, in accordance with an embodiment of the invention. Referring to FIG. 1b, there is shown WLAN channel 1 (122a), channel 4 (122b), channel 8 (122c), channel 11 (122d), and channel 13 (122e). In this regard, the channels 122a, 122b, 122c, 122d, 122e may be utilized to scan the 2.4 GHz ISM band.

The 2.4 GHz ISM frequency band may extend from 2.401 GHz to 2.483 GHz. Bluetooth may utilize the 2.4 GHz ISM frequency band as described below with respect to FIG. 4a. The five sub-bands 122a, 122b, 122c, and 122d may collectively cover the 79 Bluetooth channels. In the exemplary embodiment of the invention depicted, the sub-bands may each be 22 MHz WLAN channels, wherein WLAN channel 1 (122a) covers 2401 MHz-2423 MHz, channel 4 (122b) covers 2416 MHz-2438 MHz, channel 8 (122c) covers 2436 MHz-2458 MHz, channel 11 (122d) covers 2451 MHz-2473 MHz, and channel 13 (122e) covers 2461 MHz-2483 MHz.

In operation, a WLAN receiver may sequentially tune to the five channels, and receive on each channel for a period of time. The data received on a channel may be stored and if signal energy on a channel is above a threshold, an FFT analysis may be performed on the received data to identify any signals and/or interference on the channel. Moreover, in instances where a signal or interferer may be detected on a WLAN channel, the Bluetooth channels affected by the signal or interference may be determined. Furthermore, those affected Bluetooth channels may be classified as less desirable or undesirable for Bluetooth transmissions. In this manner, an integrated WLAN and Bluetooth system may utilize a WLAN portion to determine which Bluetooth channels may be best chosen for Bluetooth transmissions, and this information may be communicated to the Bluetooth portion of the system. The frequency hopping plan for the Bluetooth portion may thus be determined, at least in part, with the aid of the WLAN portion of the integrated Bluetooth and WLAN system.

FIG. 1c is a diagram illustrating the identification of signals utilizing a wideband receiver and classifying Bluetooth channels based on the identified signals, in accordance with an embodiment of the invention. Referring to FIG. 1c there is shown exemplary signals 152, 154, 156, and 158 which may be identified utilizing a wideband receiver which may scan the 2.4 GHz ISM frequency band by receiving signals on one or more sub-bands or channels.

The signals 152 and 158 may be WLAN transmissions on WLAN channels 2 and 9, respectively. In this regard, the signal 152 may be closer to the wideband receiver performing the scan and thus has stronger signal strength than the signal 158. Aspects of the invention may enable classification of Bluetooth channels that may overlap with the WLAN channels 2 and 9, based on the signal strength of the signals 152 and 158. For example, the strength of the signal 152 may be sufficiently high such that it would significantly interfere with Bluetooth transmissions. Accordingly, the Bluetooth channels on the frequencies 2406 MHz to 2428 MHz may be classified as undesirable for Bluetooth transmissions. In this manner, a Bluetooth system collocated with the wideband receiver may avoid transmitting on the Bluetooth channels between 2406 MHz and 2428 MHz. On the other hand, the strength of the signal 158 may be low enough such that Bluetooth transmissions on channels between 2441 may not be significantly interfered with and Bluetooth channels between 2441 MHz and 2463 MHz may be classified as acceptable or desirable.

The signals 156 may be radiation from a microwave oven, for example. Accordingly, aspects of the invention may enable classifying Bluetooth channels that overlap with the microwave oven radiation, based on the signal strength of the signals 156. For example, in instances where the microwave may be close to the wideband receiver, the radiation may be strong and may significantly interfere with Bluetooth transmission. Accordingly, Bluetooth channels near 2450 MHz may be classified as undesirable and a Bluetooth system collocated with the wideband receiver may avoid transmitting on the Bluetooth channels near 2450 MHz.

In an exemplary embodiment of the invention, classification of the Bluetooth channels may comprise ranking the Bluetooth channels according to likelihood of interference based on scans of the frequency band utilizing a wideband receiver. In this regard, when a Bluetooth transmitter is selecting a channel or series of channels on which to operate, Bluetooth channels on which interference has not been detected may be given preference over channels on which interference has sometimes been detected. Additionally, channels on which interference has sometimes been detected may be given preference over channels on which interference has frequently been detected. In this manner, Bluetooth channels may also be ranked based on the signal type detected. For example, a WLAN signal is likely to be fairly constant and thus channels the WLAN signal interferes with may be given a low preference. However, radiation from a microwave oven may be inconsistent or occur rarely, and thus even though the interference may be strong, Bluetooth channels with which the radiation interferes may be given a high priority due to the infrequent nature of microwave oven radiation. In this regard, aspects of the invention may enable storing information pertaining to detected signals and thus accumulating historical information about detected signals/interference. In this manner, Bluetooth channels which often have interference may be classified as less desirable for Bluetooth communications. Similarly, Bluetooth channels which have experience certain types of interference (e.g., microwave oven radiation) may be classified as preferable to channels which have experienced other types of interference (e.g., WLAN). Accordingly, a Bluetooth transceiver co-located with a wideband receiver may determine a channel or series of channels on which to communicate based on a trade-off between type of detected interference, strength of detected interference, and how often interference is detected.

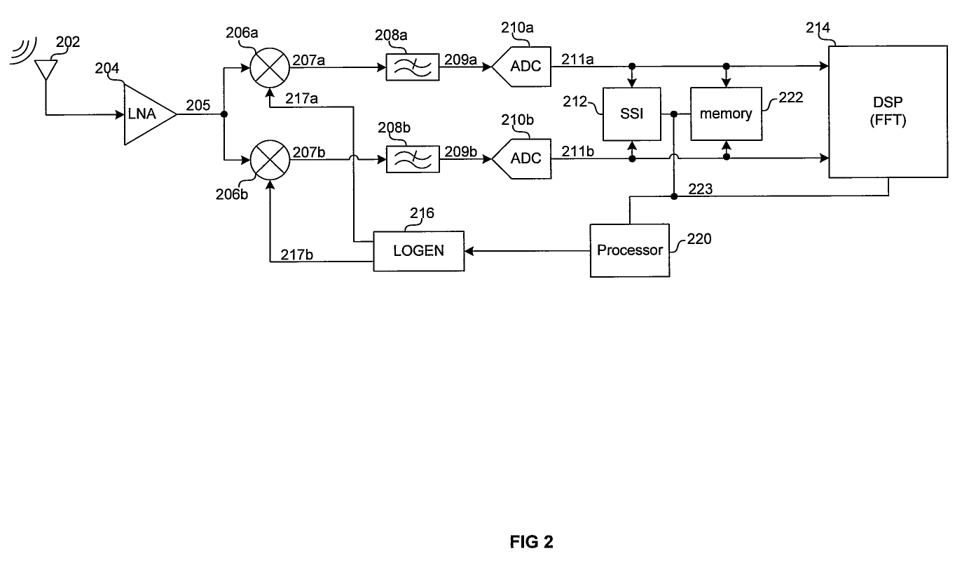

FIG. 2 is a block diagram of an exemplary wideband receiver enabled to classify Bluetooth channels, in accordance with an embodiment of the invention. Referring to FIG. 2 there is shown an exemplary wideband receiver 200 comprising an antenna 202, a low noise amplifier (LNA) 214, mixers 206a and 206b, filters 208a and 208b, analog to digital converters (ADC) 210a and 210b, signal strength indicator 212, digital signal processor 214, a local oscillator generator (LOGEN) 216, processor 220, and memory 222.

The antenna 202 may comprise suitable logic, circuitry, and/or code for receiving signals from Bluetooth and/or Wideband transceivers, such as the transceivers 508 and 514 described with respect to FIG. 5. In various embodiments of the invention there may be multiple antennas.

The LNA 214 may comprise suitable logic, circuitry, and/or code that may enable buffering and/or amplification of received RF signals. In this regard, the gain of the LNA 214 may be adjustable to enable reception of signals of varying strength. Accordingly, the LNA 214 may, for example, receive one or more control signals from the processor 220.

Each of the mixers 206a and 206b may comprise suitable logic, circuitry, and/or code that may enable generation of inter-modulation products resulting from mixing signal 205 and the local oscillator signals 217a and 217b. In this manner, received signals may be down-converted to phase-quadrature baseband signals 207a and 207b.

The Filters 208a and 208b may each comprise suitable logic, circuitry, and/or code for attenuating undesired frequencies to a greater extent than desired frequencies. In this regard, the filters 208a and 208b may, for example, have low pass or bandpass characteristics. In this manner, the filters may be enabled to reject undesired inter-modulation products output by the mixers 206a and 206b while passing desired inter-modulation products.

The ADCs 210a and 210b may each comprise suitable logic, circuitry, and/or code that may enable conversion of analog signals to a digital representation. In this regard, the ADCs 210a and 210b may, for example, sample and quantize analog signal 209a and 209b, respectively, at times specified by a sample clock. Accordingly, the ADCs 210a and 210b may receive one or more control signals from, for example, the processor 220 or the local oscillator generator 216.

The SSI 212 may comprise suitable logic, circuitry, and/or code that may enable determining signal strength. In this regard, the SSI 212 may, for example, be enabled to measure current, voltage and/or power of the signals 211a and 211b. Additionally, the SSI 212 may be enabled to convey measurement results to the processor 220 and/or the memory 222. In various embodiments of the invention, the SSI 212 may output, via the bus 223, one or more digital and/or analog signals representative of the current, voltage and/or power of the signals 211a and 211b. The SSI 212 may receive one or more control signals from the processor 220.

The digital signal processor (DSP) 214 may comprise suitable logic, circuitry, and/or code that may enable FFT analysis of received data. In this regard, the DSP 214 may perform FFT analysis of data stored in the memory 222. In various embodiments of the invention, the DSP 214 may receive one or more control signals from the processor 220. In other embodiments of the invention, the DSP 214 may be a functional block of the processor 220.

The LO generator 216 may comprise suitable logic, circuitry, and/or code that may enable generation of at least a pair of phase-quadrature local oscillator signals. For example, the LOGEN 216 may comprise a voltage controlled oscillator for generating a LO frequency and a phase splitter for generating a pair of phase quadrature signals. In various other embodiments of the invention, the LOGEN 216 may comprise a direct digital frequency synthesizer. The LOGEN 216 may receive one or more control signals from the processor 220.

The processor 220 may comprise suitable circuitry, logic, and/or code that may enable interfacing to the low noise amplifier (LNA) 214, mixers 206a and 206b, filters 208a and 208b, analog to digital converters (ADC) 210a and 210b, signal strength indicator 212, digital signal processor 214, local oscillator generator (LOGEN) 216, and memory 222. In this regard, the processor 220 may be enabled to execute one or more instructions that enable reading and/or writing to/from the memory 222. Also, the processor 220 may be enabled to execute one or more instructions that enable providing one or more control signals to the low noise amplifier (LNA) 214, mixers 206a and 206b, filters 208a and 208b, analog to digital converters (ADC) 210a and 210b, signal strength indicator 212, digital signal processor 214, a local oscillator generator (LOGEN) 216. Additionally, the processor 220 may be enabled to control the transfer of data to/from the various components of the wideband receiver 200. For example, the processor 220 may control data transfers between the SSI 212, the memory 222, and the DSP 214 via the bus 223.

The memory 222 may comprise suitable circuitry, logic, and/or code that may enable storage of information. In this regard, the memory 222 may, for example, enable storage of information utilized to control and/or configure the low noise amplifier (LNA) 214, mixers 206a and 206b, filters 208a and 208b, analog to digital converters (ADC) 210a and 210b, signal strength indicator 212, digital signal processor 214, a local oscillator generator (LOGEN) 216. The memory 222 may store received data such that an FFT may be performed on received, stored data. In an exemplary embodiment of the invention, the memory 222 may be enabled store up to 68 μs of received data. Additionally, the memory 228 may be enabled to store measurement results from the SSI 212. In various embodiments of the invention, the memory 222 may be enabled to store one or more data structures which enable determining a Bluetooth hopping sequence. In this manner, if a Bluetooth transmission is detected on a channel, the data structure may be referenced to determine the next Bluetooth channel for transmission.

In an exemplary operation, the wideband receiver 200 may be co-located with a Bluetooth transceiver. In this regard, the Bluetooth transceiver and the Bluetooth receiver may be integrated into a single chip, such as the chip 406 of FIG. 4. The wideband receiver 200 may be tuned to one of the sub-bands 102a, 102b, 102c, 102d as described with respect to FIG. 1a or 122a, 122b, 122c, 122d as described with respect to FIG. 1b. In this regard, the processor 220 may provide control signals to, for example, the LOGEN 216, and the filters 208a and 208b to tune the wideband receiver to a desired sub-band. Received signals may be received via the antenna 202 and amplified by the LNA 204. The received signals may be mixed with in-phase and quadrature-phase LO signals from the LOGEN 216 to down-convert the received signal to in-phase and quadrature-phase baseband signals 209a and 209b. The baseband signals 209a and 209b may be digitized by the ADCs 210a and 210b. The digitized signals 211a and 211b may be stored in the memory 222, and the energy in the SSI 212 may compare the energy in the digitized signals to a threshold. In instances that the energy in the digitized signal is less than the threshold, it may be determined that no signals are present in the sub-band. However, in instances that the energy in the digitized signals is greater than the threshold, then the DSP 214 may perform a FFT analysis of the received, stored data. Accordingly, the results of the FFT may enable determining the type of signal present in the sub-band. Accordingly, aspects of the invention may enable identification of signals such as Bluetooth transmission, WLAN transmissions, and microwave oven radiation. In instances when a signal may be present in the sub-band, it may interfere with Bluetooth transmissions by the collocated Bluetooth transmitter. Accordingly, aspects of the invention may enable classifying or ranking the Bluetooth channels as either more of less desirable for Bluetooth transmissions, as based on signals/interference detected by the wideband receiver. For example, the Bluetooth channels may be classified based on strength, type, or occurrence of interfering signals detected by the wideband receiver 200. In this regard, a Bluetooth transceiver co-located with the wideband receiver may utilize the classification of the Bluetooth channels to determine a Bluetooth channel or series of Bluetooth channels which may provide best chance of successful Bluetooth communication with a remote Bluetooth transceiver.

In an exemplary embodiment of the invention, the wideband receiver 200 may comprise a WLAN or “Wi-Fi” receiver. In this regard, the wideband receiver 200 may be enabled to adhere to one or more IEEE 802.11 standards. For example, a WLAN standard may utilize approximately 20 MHz wide or 40 MHz wide channels, and accordingly one or more non-overlapping WLAN channels (e.g., channels 1, 4, 8, and 11) may be utilized as the sub-bands. Accordingly, a Bluetooth transceiver and a wideband receiver may be co-located, such as in the chip 506 as described with respect to FIG. 4.

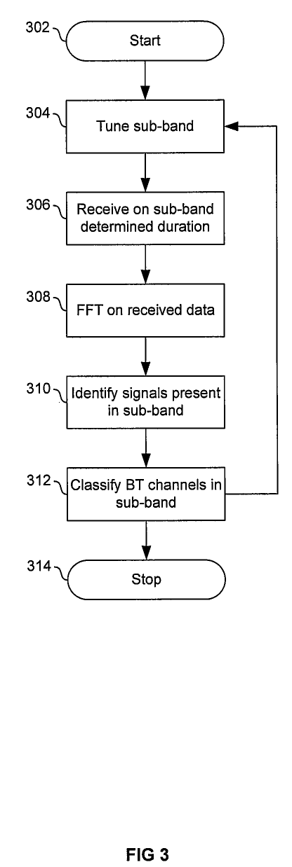

FIG. 3 is a flow chart illustrating exemplary steps for utilizing a wideband receiver for classifying Bluetooth channels, in accordance with an embodiment of the invention. Referring to FIG. 3 the exemplary steps may begin with start step 302. Subsequent to step 302 the exemplary steps may advance to step 304. In step 304, the wideband receiver 200 may be tuned to a desired sub-band within the 2.4 GHz ISM frequency band. Subsequent to step 304, the exemplary steps may advance to step 306. In step 306, the wideband receiver 200 may receive data on the tuned-to sub-band for a determined duration of time. Subsequent to step 206, the exemplary steps may advance to step 308. In step 308, an FFT analysis may be performed on the received data. Subsequent to step 308, the exemplary steps may advance to step 310. In step 310, the results of the FFT may be utilized to determine whether any signals or interference may be present in the sub-band. Additionally, the signal or interference may be identified based on its spectral characteristics. Subsequent to step 310, the exemplary steps may advance to step 312. In step 312, a preference may be assigned to Bluetooth channels based on signals or interference detected by the wideband receiver. In this regard, preference may be based, for example, on strength, type, and/or likelihood of occurrence of the signal or interference. A co-located Bluetooth transceiver may utilize the classifications of the Bluetooth channels in order to determine a Bluetooth channel or series of Bluetooth channels which may provide the best communication link to a remote Bluetooth transceiver. Subsequent to step 312, the exemplary steps may advance to step 314.

FIG. 4 is a block diagram illustrating an exemplary wireless device, in accordance with an embodiment of the invention. Referring to FIG. 4 there is shown a wireless device 404, a WLAN transceiver 414, and a BT transceiver 408.

The WLAN transceiver 414 may, for example, transmit and receive signals adhering to a wireless standard such as the IEEE 802.11 family of standards. In this regard, the WAN transceiver 414 may utilize orthogonal frequency division multiplexing (OFDM) and may operate on one of eleven 22 MHZ wide WLAN channels. The WLAN transceiver may be implemented as part of a wireless router and may operate in the 2.4 GHz ISM band.

The Bluetooth transceiver 408 may, for example, adhere to one or more Bluetooth standards transmitting and receiving RF signals at or near 2.4 GHz. In this regard, the Bluetooth transceiver 408 may utilize frequency hopping spread spectrum and may hop between the 79 1 MHz wide Bluetooth channels depicted in FIG. 4a. The Bluetooth transceiver 408 may be implemented as, for example, part of a wireless headset utilized to transfer voice and/or audio information to/from the wireless device 404.

The wireless device 404 may comprise an RF receiver 423a, an RF transmitter 423b, a digital baseband processor 429, a processor 425, and a memory 427. A receive antenna 421a may be communicatively coupled to the RF receiver 423a. A transmit antenna 421b may be communicatively coupled to the RF transmitter 423b.

The RF receiver 423a may comprise suitable logic, circuitry, and/or code that may enable processing of received RF signals. The RF receiver 423a may enable receiving RF signals in a plurality of frequency bands. For example, the RF receiver 423a may enable receiving signals in ISM frequency bands. Each frequency band supported by the RF receiver 423a may have a corresponding front-end circuit for handling low noise amplification and down conversion operations, for example. In this regard, the RF receiver 423a may be referred to as a multi-band receiver when it supports more than one frequency band. In another embodiment of the invention, the wireless device 404 may comprise more than one RF receiver 423a, wherein each of the RF receiver 423a may be a single-band or a multi-band receiver.

The RF receiver 423a may down convert the received RF signal to a baseband signal that comprises an in-phase (I) component and a quadrature (Q) component. The RF receiver 423a may down convert the received RF signal to a baseband signal, for example. In some instances, the RF receiver 423a may enable analog-to-digital conversion of the baseband signal components before transferring the components to the digital baseband processor 429. In other instances, the RF receiver 423a may transfer the baseband signal components in analog form.

The digital baseband processor 429 may comprise suitable logic, circuitry, and/or code that may enable processing and/or handling of baseband signals. In this regard, the digital baseband processor 429 may process or handle signals received from the RF receiver 423a and/or signals to be transferred to the RF transmitter 423b, when the RF transmitter 423b is present, for transmission to the network. The digital baseband processor 429 may also provide control and/or feedback information to the RF receiver 423a and to the RF transmitter 423b based on information from the processed signals. The digital baseband processor 429 may communicate information and/or data from the processed signals to the processor 425 and/or to the memory 427. Moreover, the digital baseband processor 429 may receive information from the processor 425 and/or to the memory 427, which may be processed and transferred to the RF transmitter 423b for transmission to the network.

The RF transmitter 423b may comprise suitable logic, circuitry, and/or code that may enable processing of RF signals for transmission. The RF transmitter 423b may enable transmission of RF signals in a plurality of frequency bands. For example, the RF transmitter 423b may enable transmitting signals in ISM frequency bands. Each frequency band supported by the RF transmitter 423b may have a corresponding front-end circuit for handling amplification and up conversion operations, for example. In this regard, the RF transmitter 423b may be referred to as a multi-band transmitter when it supports more than one frequency band. In another embodiment of the invention, the wireless device 404 may comprise more than one RF transmitter 423b, wherein each of the RF transmitter 423b may be a single-band or a multi-band transmitter.

The RF transmitter 423b may quadrature up convert the baseband signal comprising I/Q components to an RF signal. The RF transmitter 423b may perform direct up conversion of the baseband signal to a RF signal, for example. In some instances, the RF transmitter 423b may enable digital-to-analog conversion of the baseband signal components received from the digital baseband processor 429 before up conversion. In other instances, the RF transmitter 423b may receive baseband signal components in analog form.

The processor 425 may comprise suitable logic, circuitry, and/or code that may enable control and/or data processing operations for the wireless device 404. The processor 425 may be utilized to control at least a portion of the RF receiver 423a, the RF transmitter 423b, the digital baseband processor 429, and/or the memory 427. In this regard, the processor 425 may generate at least one signal for controlling operations within the wireless device 404. The processor 425 may also enable executing of applications that may be utilized by the wireless device 404. For example, the processor 425 may execute applications that may enable displaying and/or interacting with content received via Bluetooth and/or WLAN in the wireless device 404.

The memory 427 may comprise suitable logic, circuitry, and/or code that may enable storage of data and/or other information utilized by the wireless device 404. For example, the memory 427 may be utilized for storing processed data generated by the digital baseband processor 429 and/or the processor 425. In this regard, the memory 427 may store information pertaining to detected interference. The memory 427 may also be utilized to store information, such as configuration information, that may be utilized to control the operation of at least one block in the wireless device 404. For example, the memory 427 may comprise information necessary to configure the RF receiver 423a to enable receiving Bluetooth and/or WLAN in the appropriate frequency band.

The multi-function wireless chip 406 may comprise suitable logic, circuitry, and/or code that may enable the wireless device 404 to communicate with the WLAN transceiver 414 and the BT transceiver 408. The chip 406 may be enabled to transmit and/or receive Bluetooth signals and WLAN signals. Accordingly, the chip 406 may utilize advanced and/or specialized signal processing techniques in order to minimize interference between the various wireless technologies. The chip 406 may comprise suitable logic, circuitry, and/or code that may be enable utilization of a Fast Fourier transform (FFT) for processing received signals.

Aspects of a method and system for classifying Bluetooth channels using a wideband receiver (e.g., the wideband receiver 200 of FIG. 2) are provided. In this regard, FFT analysis may be utilized to detect signals/interference (e.g., signals 152, 156, 158 of FIG. 1c) present in a sub-band of an ISM band and classify Bluetooth channels in that sub-band based on the detected signals. A co-located Bluetooth transceiver, such as in the chip 406 of FIG. 4, may utilize the classification to determine which Bluetooth channels comprise a best communication link for Bluetooth communications. In this regard, Bluetooth channels may be ranked in order of preference based on the classification. Preferred Bluetooth channels may provide more reliable Bluetooth communications. The ISM frequency band may be the 2.4 GHz ISM frequency band, as depicted in FIGS. 1a, 1b, 1c. The sub-bands day each comprise the WLAN channels 122a-122e. Bluetooth channels may be classified based on strength, type, and/or a rate of recurrence of the detected signals. In addition to the FFT, a signal strength indicator (e.g., the SSI 212 of FIG. 2) may be utilized to detect signals/interference.

Another embodiment of the invention may provide a machine-readable storage, having stored thereon, a computer program having at least one code section executable by a machine, thereby causing the machine to perform the steps as described herein for classifying Bluetooth channels using a wideband receiver.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for wireless communication, the method comprising:
detecting, utilizing Fast Fourier Transform analysis, signals present in one or more sub-bands of an ISM frequency band; and
classifying Bluetooth channels based on said detected signals.

2. The method according to claim 1, comprising classifying said Bluetooth channels based on a strength of said detected signals.

3. The method according to claim 1, comprising classifying said Bluetooth channels based on a type of said detected signals.

4. The method according to claim 1, comprising classifying said Bluetooth channels based on a rate of recurrence of said detected signals.

5. The method according to claim 1, wherein each of said sub-bands is a wireless local area networking channel.

6. The method according to claim 1, comprising detecting said signals utilizing a signal strength indicator.

7. The method according to claim 1, comprising determining which of said Bluetooth channels to utilize for Bluetooth communications based on said classification of said Bluetooth channels.

8. The method according to claim 1, wherein said ISM frequency band comprises the 2.4 GHz ISM frequency band.

9. A machine-readable storage having stored thereon, a computer program having at least one code section for wireless communication, the at least one code section being executable by a machine for causing the machine to perform steps comprising:
detecting, utilizing Fast Fourier Transform analysis, signals present in one or more sub-bands of an ISM frequency band; and
classifying Bluetooth channels based on said detected signals.

10. The machine-readable storage according to claim 9, wherein said at least one code section comprise code for classifying said Bluetooth channels based on a strength of said detected signals.

11. The machine-readable storage according to claim 9, wherein said at least one code section comprise code for classifying said Bluetooth channels based on a type of said detected signals.

12. The machine-readable storage according to claim 9, wherein said at least one code section comprise code for classifying said Bluetooth channels based on a rate of recurrence detected signals.

13. The machine-readable storage according to claim 9, wherein said at least one code section comprise code for each of said sub-bands is a wireless local area networking channel.

14. The machine-readable storage according to claim 9, wherein said at least one code section comprise code for detecting said signals utilizing a signal strength indicator.

15. The machine-readable storage according to claim 9, wherein said at least one code section comprise code for determining which of said Bluetooth channels to utilize for Bluetooth communications based on said classification of said Bluetooth channels.

16. The machine-readable storage according to claim 9, wherein said ISM frequency band comprises the 2.4 GHz ISM frequency band.

17. A system for wireless communication, the system comprising:
one or more circuits that:
detect, utilizing Fast Fourier Transform analysis, signals present in one or more sub-bands of an ISM frequency band; and
classify Bluetooth channels based on said detected signals.

18. The system according to claim 17, wherein said one or more circuits classify said Bluetooth channels based on a strength of said detected signals.

19. The system according to claim 17, wherein said one or more circuits classify said Bluetooth channels based on a type of said detected signals.

20. The system according to claim 17, wherein said one or more circuits classify said Bluetooth channels based on a rate of recurrence of said detected signals.

21. The system according to claim 17, wherein each of said sub-bands is a wireless local area networking channel.

22. The system according to claim 17, wherein said one or more circuits comprise a signal strength indicator.

23. The system according to claim 17, wherein said one or more circuits determine which of said Bluetooth channels to utilize for Bluetooth communications based on said classification of said Bluetooth channels.

24. The system according to claim 17, wherein said ISM frequency band comprises the 2.4 GHz ISM frequency band.
